(19) United States
(12) Patent Application Publication
(10) Pub. No.: US 2006/0019074 A1
(43) Pub. Date: Jan. 26, 2006

(54) Printed article having texture printing and a uniform surface gloss to simulate embossing and method of manufacturing same

(75) Inventors: Joel Scott Scarbrough, Burlington, WI (US); Daniel C. Faul, West Bend, WI (US)

Correspondence Address: GODFREY & KAHN S.C., 780 NORTH WATER STREET, MILWAUKEE, WI, 53202, US

(73) Assignee: Serigraph Inc.

(21) Appl. No.: 11/233,971

(22) Filed: Sep. 23, 2005

Related U.S. Application Data
(63) Continuation-in-part of application No. 10/239,691, filed on Mar. 31, 2003.

(51) Int. Cl. B32B 3/00

(52) U.S. Cl. 428/195.1

(57) ABSTRACT

A printed article including a substrate having a top surface and a bottom surface with a reflective layer printed on a surface of the substrate, a graphic design layer printed on the reflective layer, a textured pattern of transparent ink printed over the graphic design and reflective layer, and a transparent layer of uniform gloss printed over (or directly under the texture pattern if the gloss level of the transparent layer of uniform gloss matches the gloss level of the texture pattern) the textured pattern. This transparent layer of uniform gloss printed over the texture printing (or a matching gloss level under the texture printing) is such that the texture printing is not distinct from the non texture printed areas and the image appears to be embossed to the human eye. The textured pattern includes a plurality of light bending convex lines of transparent ink printed on and around the graphic image and reflective layers. The lines produce a textured surface on the printed article creating the illusion of depth and three-dimensionality.

### CROSS-REFERENCE TO RELATED APPLICATIONS

This application is a continuation-in-part of U.S. patent application Ser. No. 10/239,691, filed Mar. 31, 2003.

### BACKGROUND OF THE INVENTION

The present invention relates generally to a printed article, and more particularly to a printed article having a graphic design such as a trading card, greeting card, sign, poster, label, decal, book cover, decorative panel, name plate, a visual display or the like having a uniform gloss level with a textured pattern printed thereon by a printing method that makes the graphic design images come alive with depth, texture and three-dimensionality, thereby simulating an embossed image.

In order to attract the attention of consumers, many products are being manufactured with images that provide a unique and sensational visual presentation. To meet this demand, a variety of printing techniques have been developed to produce aesthetically pleasing visual effects, such as the appearance of depth and three-dimensionality. Various methods are known in the prior art that produce three-dimensional images on two-dimensional media.

One method involves printing two offset images in different colors on an opaque or transparent sheet, and viewing the images using special glasses having right and left lenses which correspond to the different image colors respectively. Holographic technology can also be used to produce am image on a flat sheet which appears three-dimensional when illuminated and viewed at the proper angles.

However, these methods have not been commercially popular for various reasons. The offset image method is undesirable in that special glasses are required to view the image. Holograms are difficult and expensive to produce. Therefore, processes have been developed to produce the illusion of three-dimensional images on two-dimensional media. One such process is conventional embossing, which forms a raised pattern on a substrate by physically deforming part of the substrate upwardly. However, embossing suffers from the drawback that an expensive press is necessary to perform the operation, and a die bearing the desired embossed pattern must be made for each application. Further, the materials that can be used for embossing are limited because of the deforming nature of the embossing process.

Therefore, a need exists for an economical printing method and resulting printed articles that offer the visual impact of embossing without the cost. The assignee of the present invention has developed a number of printing processes for printing a variety of visually stimulating vibrant images creating the illusion of depth, texture and three-dimensionality as disclosed in U.S. Pat. Nos. 5,762,379, 6,113,149 and 6,170,881, the disclosures of which are incorporated herein by reference. The present invention provides an improved printing method for printing vibrant images on printed articles having the illusion of depth, texture and three-dimensionality.

### SUMMARY OF THE INVENTION

Therefore, it is an object of the present invention to provide a printed article and printing method that overcomes the drawbacks of the prior art. It is another object of the present invention to provide an economical printing method for printing images on a printed article creating the illusion of depth, texture, three-dimensionality, and simulated embossing. It is a further object of the invention to provide a printed article with a textured pattern printed over a graphic image printed on a reflective surface by a four-color offset printing process. It is yet another object of the invention to provide a printing process for printing images on a printed article creating visual impressions which change as the viewing angle of the printed article is changed.

The present invention is an improvement of U.S. Pat. No. 5,762,379, assigned to the assignee of the present invention, and incorporated herein by reference. The present invention provides a much less expensive method of producing a printed article having a uniform gloss appearance with a graphic design creating the illusion of an embossed article. The printed article of the present invention creates the illusion of an embossed article with a textured pattern printed over and/or around a graphic design or image that is printed on a reflective surface with a transparent layer of uniform gloss printed over or under the textured pattern. The visual effect simulating an embossed article is achieved with the texture ink effectively being hidden by the overall uniform gloss layer.

The present invention includes a substrate having a top surface and a bottom surface. The substrate may be formed of any suitable type of printable material. A reflective layer is preferably printed over the surface of the substrate. Alternatively, a reflective ink or foil may be deposited or laminated on the top surface of the substrate. A graphic design or image is printed over the reflective layer. The image may cover the entire portion of the reflective layer or only selected portions thereof. The image may comprise a plurality of ink layers in order to produce the desired graphic design. The graphic image is preferably applied to the reflective layer through a four-color offset printing process where a base layer is printed and a four-color image is printed over the base layer. Printed on top of the graphic image is a plurality of light bending textured lines to produce the desired visual effect of depth and three-dimensionality. These lines, convex in cross section, produce a reflective textured pattern on the surface of the printed article. A layer of transparent ink of uniform gloss is printed over the graphic layers and over the surface of the textured lines and graphic image. Alternatively, this transparent layer of uniform gloss can be printed over the graphic layers but under the textured lines as long as the uniform gloss of this clear layer is the same gloss level as the textured lines. If the human eye can not perceive the difference between the gloss level of the texture and the uniform gloss level of the transparent layer, then the article will appear to be embossed as opposed to simply printed with textured lines. The inks used in the present invention are preferably curable in response to the application of ultraviolet light.

The graphic image may be printed with opaque ink, semi-transparent ink, translucent ink, or any combination thereof. These inks are preferably curable in response to ultraviolet (UV) light. Methods of forming the graphic image include silk screening, lithography, flexography, gravure or other known printing methods.

The textured pattern includes raised portions for bending and reflecting light incident to the printed article. The textured pattern or textured lines are formed from a transparent ink printed on all or parts of the image by a printing process such as silk screening, lithography, flexography, coating or other known printing method. The printed lines create lenses that have a convex curvature to refract incident light in a manner to control the reflected light and magnify portions of the graphic image to create varying depths and dimensions to the finished part.

Various other features, objects, and advantages of the invention will be made apparent to those skilled in the art from the accompanying drawings and detailed description thereof.

### BRIEF DESCRIPTION OF THE DRAWINGS

FIG. 1 is an enlarged cross-sectional view of an embodiment of a printed article produced in accordance with the present invention;

FIG. 1A is an enlarged cross-sectional view of the printed article of FIG. 1 with printing on both the top and bottom surfaces of the printed article;

FIG. 2 is an enlarged cross-sectional view of another embodiment of a printed article produced in accordance with the present invention;

FIG. 2A is an enlarged cross-sectional view of a modification of the printed article of FIG. 2 with printing on both the top and bottom surfaces of the printed article;

FIG. 3 is an enlarged cross-sectional view illustrating another embodiment of a printed article produced in accordance with the present invention;

FIG. 3A is an enlarged cross-sectional view of the printed article of FIG. 3 with printing on both the top and bottom surfaces of the printed article;

FIG. 4 is an enlarged cross-sectional view illustrating another embodiment of a printed article produced in accordance with the present invention;

FIG. 4A is an enlarged cross-sectional view of the printed article of FIG. 4 with printing on both the top and bottom surfaces of the printed article;

FIG. 5 is an enlarged cross-sectional view illustrating another embodiment of a printed article produced in accordance with the present invention;

FIG. 5A is an enlarged cross-sectional view of the printed article of FIG. 5 with printing on both the top and bottom surfaces of the printed article;

FIG. 6 is an enlarged cross-sectional view of another embodiment of a printed article produced in accordance with the present invention;

FIG. 6A is an enlarged cross-sectional view of the embodiment of FIG. 6 with printing on both the top and bottom surfaces of the printed article; and

FIG. 7 is a top plan view of a trading card having an image produced in accordance with the present invention.

### DETAILED DESCRIPTION OF THE INVENTION

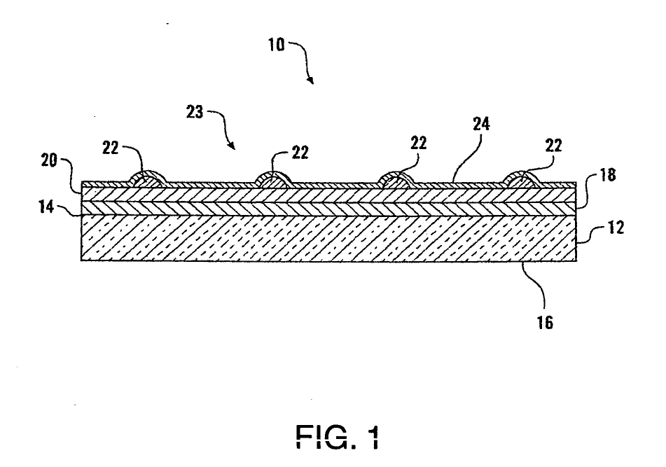

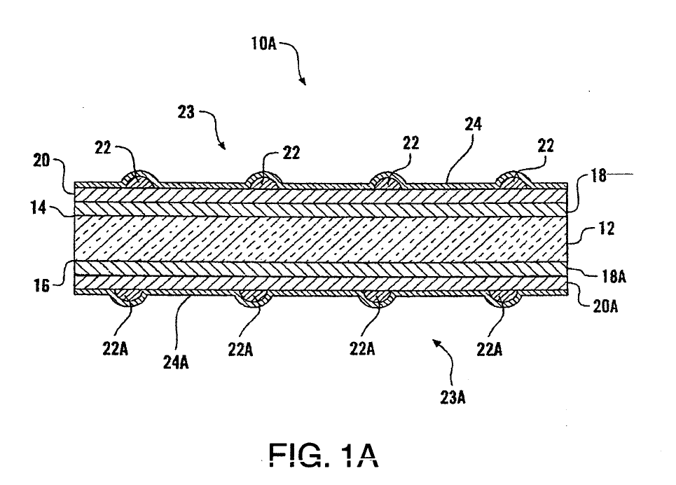

Referring now to the drawings, FIG. 1 illustrates an enlarged cross sectional view of an embodiment of a printed article produced in accordance with the present invention. The printed article 10 includes a substrate 12 having a top surface 14 and a bottom surface 16. The substrate 12 can be formed of paper, cardboard, plastic, acrylic, glass, metal or any other suitable printable material.

A reflective or ink layer 18 is printed over all or a portion of the top surface 14 of the substrate 12. The reflective layer 18 is preferably formed of reflective ink which is printed onto the substrate 12. The reflective layer 18 can be clear or have color. The reflective layer 18 can be opaque, transparent, semi-transparent or translucent. The reflective layer 18 gives the printed article a shiny reflective or metallic appearance. Alternatively, the reflective layer 18 can be formed of a chrome film, diffraction film, metallic foil, holographic foil, roll leafing or any other metalized material having a reflective surface.

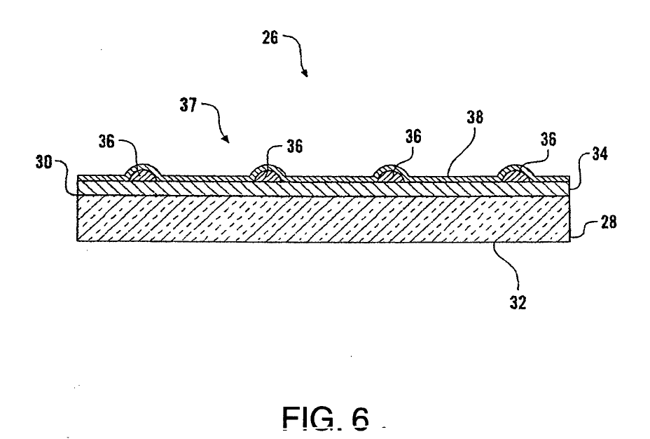

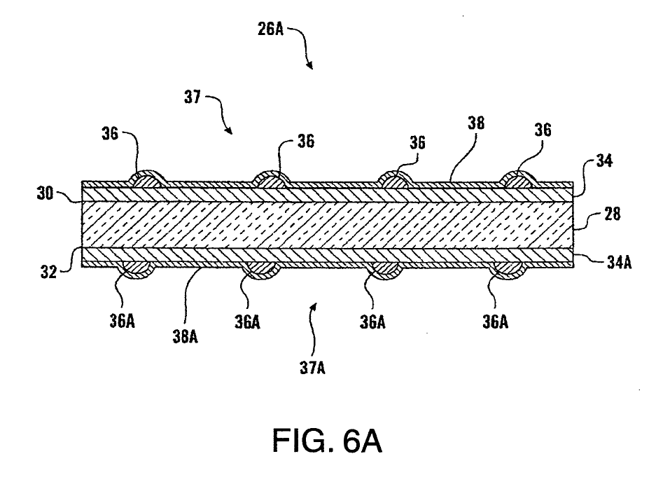

A graphic design or image 20 is printed over all or a portion of the reflective layer 18. The image 20 can have any desired form, for example, a football player on a sports trading card as shown in FIG. 6, or any other image. The graphic design or image 20 may comprise a plurality of ink layers in order to provide the desired design. A preferred method of forming the graphic image 20 is through a four-color offset printing process where a base layer is printed and a four-color image is printed over the base layer. The graphic image 20 may be printed with opaque ink, semi-transparent ink, translucent ink, or any combination thereof. These inks are preferably curable in response to ultraviolet (UV) light. Methods of forming the graphic image 20 include silk screening, lithography, flexography, gravure or other known printing methods.

A textured pattern 23 is printed over and/or around the graphic design or image 20. The textured pattern includes a plurality of convex rounded ridges, irregular textures, or lines 22 of transparent ink printed over and/or around the graphic design or image 20. In the preferred embodiment, the height and thickness of the lines is approximately 0.5 mils to 2 mils. However, the thickness, height and spacing of the lines may vary depending upon the particular application and desired visual effect. The textured pattern 23 can be formed over the entire surface of the image 20 or over only a portion thereof. The textured pattern 23 of lines 22 is preferably formed from a transparent ink, such as Nasdar 3527, Radcure VM4SP, or the like, printed on top of the graphic design or image 20 by a printing method such as silk screening, lithography, flexography, offset printing, gravure, select coating or other known printing method. The transparent ink has rheological properties such that when it is applied, it flows into semi-cylindrical or other types of convex shapes when viewed in cross-section. This transparent ink is also preferably a UV curable ink. The transparent ink may also include flakes of glitter, pearls, or other materials to produce a “glittery” effect.

The textured pattern 23 gives the appearance of a raised or embossed effect, which simulates depth, three-dimensionality, and embossing. The semi-cylindrically shaped raised ridges, textures or lines 22, bend and reflect light incident on the printed article 10, producing the visual illusion of depth, texture, three-dimensionality and embossing in the printed article as it is viewed from different angles. Light incident on the printed article 10 is reflected off the reflective layer 18 back through the graphic design or image 20 and the textured pattern 23 to create a unique visual effect.

A transparent layer of uniform gloss 24, is printed over the textured pattern 23, of lines 22, and the graphic design or image 20. The transparent layer of uniform gloss 24, must be thin enough not to diminish the light bending, magnification, and reflective properties of the textured pattern 23 and the lines 22 of the textured pattern 23. The controlled gloss layer 24 is preferably formed of substantially transparent ink. This transparent layer of uniform gloss layer 24, provides a uniform gloss appearance over the textured pattern and gives the printed article a uniform level of gloss over textured and non-textured areas as desired.

Light incident on the printed article 10 from above is reflected off the reflective layer back through the graphic design or image, the textured pattern and the uniform gloss layer, such that the printed article exhibits depth, texture, three-dimensionality, and appears to be embossed in those areas with texture patterns.

FIG. 1A illustrates the printed article 10 of FIG. 1 with printing on both the top 14 and bottom 16 surfaces of the substrate 12. The printed article 10A of FIG. 1A includes a second reflective layer 18A printed on the bottom surface 16 of the substrate 12, a second graphic design or image 20A printed over and/or around the second reflective layer 18A, a second textured pattern 23A of lines 22A printed on the second graphic design or image 20A, and a second transparent layer of uniform gloss level ink 24A printed on the second textured pattern 23A and the second graphic design or image 20A.

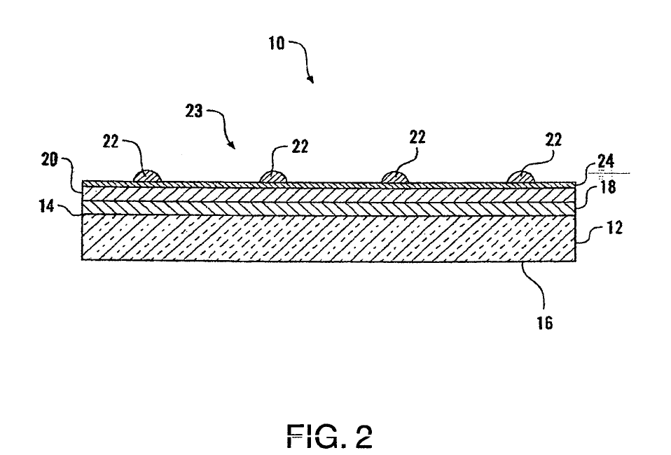

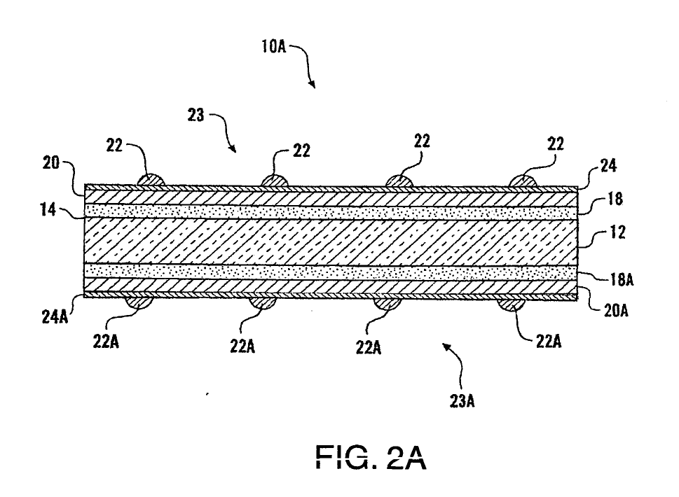

FIGS. 2 and 2A, show another embodiment of the present invention. This embodiment demonstrates a change in the sequence of the layers to achieve an equivalent appearance as that obtained in FIGS. 1 and 1A. In this embodiment, the transparent layer of uniform gloss, 24 and 24A, has been printed over the reflective layer 18 or 18A, over the graphic design or image, 20 or 20A, and under the texture pattern, 23 or 23A. For the effect of simulated embossing to still be achieved as in FIGS. 1 and 1A, the gloss level of the transparent uniform gloss layer must be equal to the gloss level of the texture pattern. In the case of high gloss effects, the transparent layer and the texture pattern are both high gloss transparent layers and can be produced from the same raw materials. For an embossed appearance on a low gloss, matte, or velvet type appearance, the uniform transparent layer and the texture pattern would both be produced from materials that are low gloss, matte, or velvet type appearance, respectively.

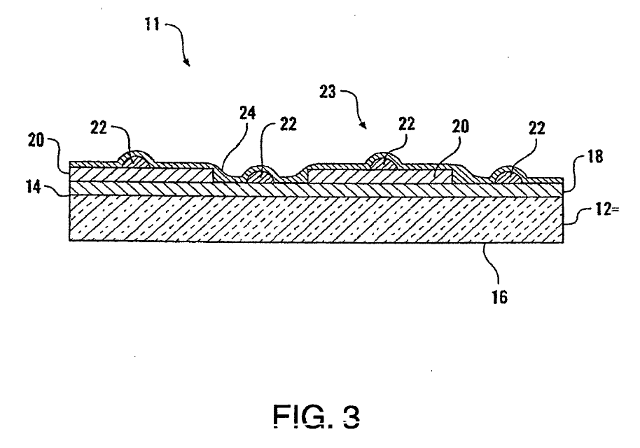

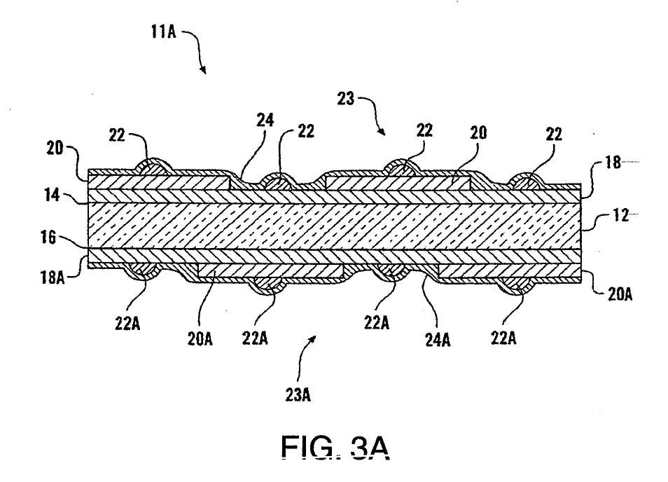

FIGS. 3, 3A, 4, 4A, 5 and 5A show different embodiments of printed articles 11, 11A, 13, 13A, 15 and 15A of the embodiment shown in FIGS. 1 and 1A. For simplicity, the embodiments are shown based on the sequences presented in FIGS. 1 and 1A, but in all of these embodiments, the transparent layer of uniform gloss can alternatively be printed under the texture pattern, when the gloss level of the transparent and texture layer are equal.

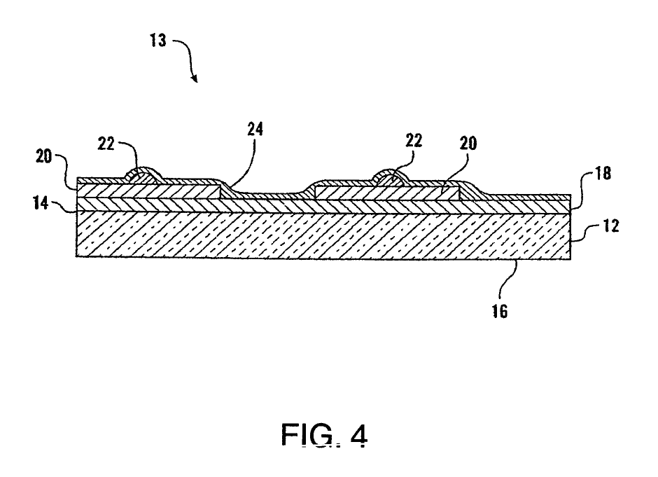

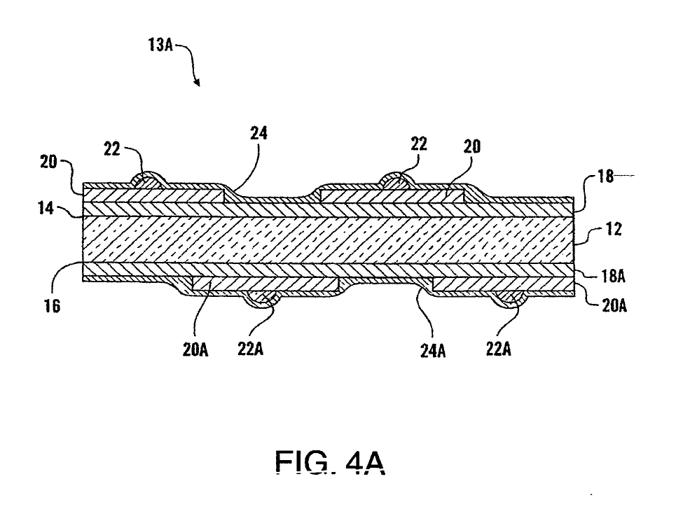

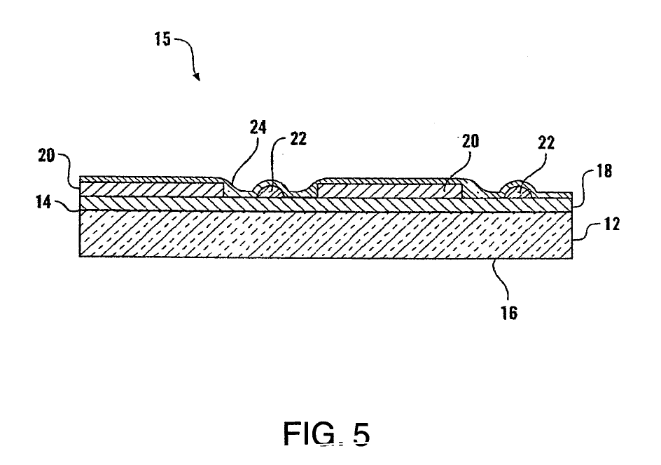

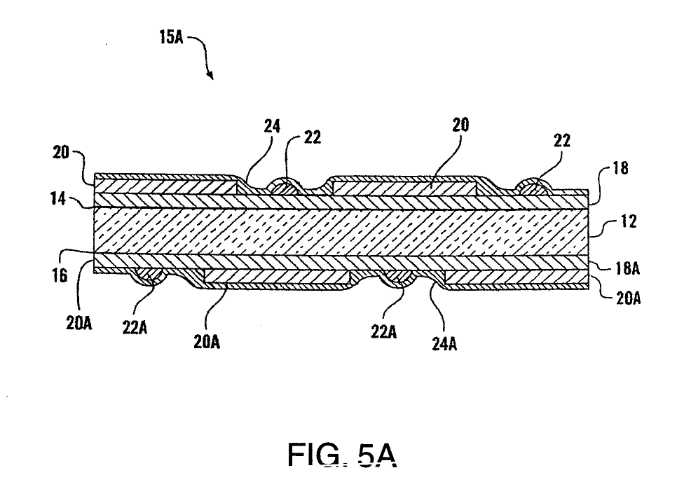

As shown in FIGS. 3 and 3A, variations of printed articles 11 and 11A include a graphic design or image 20, 20A printed on selected portions of a reflective layer 18, 18A with a textured pattern 23, 23A of lines 22, 22A printed on both the reflective layer 18, 18A and graphic image 20, 20A. A transparent layer of uniform gloss 24 is applied as the topmost layer or alternatively, as in FIGS. 2, 2A this transparent layer of uniform gloss can be printed underneath the texture lines 22, 22A if the gloss level of the transparent layer of uniform gloss 24 is equal to the gloss level of the texture lines 22, 22A. In FIGS. 4 and 4A, variations 13 and 13A include a graphic design or image 20, 20A printed on selected portions of a reflective layer 18, 18A with a textured pattern 23, 23A of lines 22, 22A printed only on the graphic image 20, 20A. And as shown in FIGS. 5 and 5A, variations 15 and 15A includes a graphic design or image 20, 20A printed on selected portions of a reflective layer 18, 18A with a textured pattern 23, 23A of lines 22, 22A printed only on the reflective layer 18, 18A.

FIG. 6 illustrates an enlarged cross sectional view of another embodiment of a printed article 26 produced in accordance with the present invention. The difference between this embodiment and the earlier described embodiments is that this embodiment does not include a reflective layer printed on the surface of the substrate.

The printed article 26 of the second embodiment includes a substrate 28 having a top surface 30 and a bottom surface 32. A graphic design or image 34 is printed over all or a portion of the top surface 30 of the substrate 28. The graphic design or image 34 may comprise a plurality of ink layers in order to provide the desired design. A preferred method of forming the graphic image 34 is through a four-color offset printing process where a base layer is printed and a four-color image is printed over the base layer. The graphic image 34 may be printed with opaque ink, semi-transparent ink, translucent ink, or any combination thereof. These inks are preferably curable in response to ultraviolet (UV) light. Other methods of forming the graphic image 34 include silk screening, lithography, flexography, gravure or other known printing methods.

A textured pattern of lines 36 is printed over the graphic design or image 34. The textured pattern of lines 36 includes a plurality of convex ridges or curved lines of transparent ink. The textured pattern of lines is preferably printed over all or a portion of the graphic design or image 34. The textured pattern of lines 36 creates an illusion of depth, texture and three-dimensionality in the printed article 26.

A textured pattern 37 is printed over and/or around the graphic design or image 34. The textured pattern 37 includes a plurality of parallel convex rounded ridges or lines 36 of transparent ink printed over and/or around the graphic design or image 34. In the preferred embodiment, the height and thickness of the lines is approximately 0.5 mils to 2 mils. However, the thickness, height and spacing of the lines may vary depending upon the particular application and desired visual effect. The textured pattern 37 can be formed over the entire surface of the image 34 or over only a portion thereof. The textured pattern 37 of lines 36 is preferably formed from a transparent ink, such as Nasdar 3527, Radcure VM4SP, or the like, printed on top (or underneath) of the graphic design or image 34 by a printing method such as silk screening, lithography, flexography, offset printing, gravure, coating or other known printing method. The transparent ink has rheological properties such that when it is applied, it flows into a semi-cylindrical or other type of convex shape when viewed in cross-section. This transparent ink is also preferably a UV curable ink. The transparent ink may also include flakes of glitter, pearls, or other materials to produce a “glittery” effect.

The textured pattern 37 gives the appearance of a raised or embossed effect, which simulates depth and three-dimensionality. The semi-cylindrically shaped raised ridges or lines 36 bend and reflect light incident on the printed article 26 producing the visual illusion of depth, texture and three-dimensionality in the printed article as it is viewed from different angles. Light incident on the printed article 26 is reflected off the surface of the substrate 28 back through the graphic design or image 34 and the textured pattern 37 to create a unique visual effect.

A transparent layer of uniform gloss 38 is printed over the textured pattern 37 of lines 36 and the graphic design or image 34, (or alternatively, the transparent layer of uniform gloss can be printed underneath the texture pattern 37 of lines 36, if the gloss level is equal to gloss level of the texture pattern). The transparent layer of uniform gloss 38 must be thin enough not to diminish the glossy and reflective properties of the textured pattern 27. The transparent layer of uniform gloss 38 is preferably formed of clear polyester by thermal lamination or by printing or coating with a clear plastic or ink. The transparent layer of uniform gloss 38 can also be formed of a pressure sensitive sheet using cold lamination. The transparent layer of uniform gloss 38 provides a level of gloss appearance matching that of the textured pattern 37 and gives the printed article 26 an overall gloss level that is not distinguished between textured and non-textured areas. It is this uniform gloss that deceives the eye to provide the appearance of an embossed article.

FIG. 6A illustrates the printed article 26 of FIG. 6 with printing on both the top 30 and bottom 32 surfaces of the substrate 28. The printed article 26A of FIG. 6A includes a second graphic design or image 34A printed on the bottom surface 32 of the substrate 28, a second textured pattern 37A of lines 36A printed on the second graphic design or image 34A, and a second layer of uniform gloss transparent ink 38A printed on the second textured pattern 37A of lines 36A and the second graphic design or image 34A.

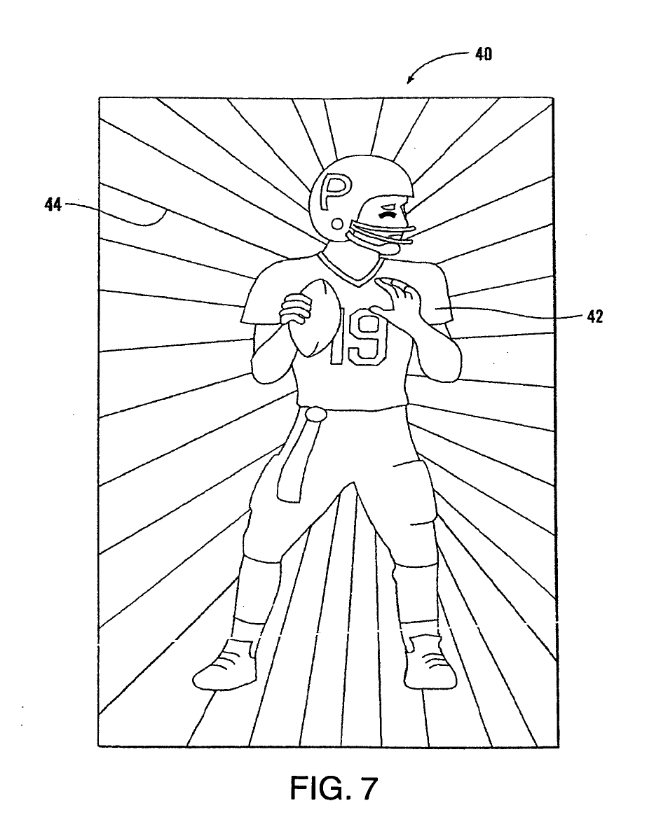

FIG. 7 illustrates an example of a sport trading card 40 manufactured in accordance with the present invention. The card 40 includes the image of a football player 42 printed over a reflective layer covering the top surface of the card. Printed on and around the image 42 is a plurality of textured pattern of lines 44. The textured pattern of lines 44 are produced from transparent ink to create depth and three-dimensionality in the printed image and an overall shiny or glossy textured appearance of the printed article.

While the invention has been described with reference to preferred embodiments, those skilled in the art will appreciate that certain substitutions, alterations, and omissions may be made without departing from the spirit of the invention. Accordingly, the foregoing description is meant to be exemplary only and should not limit the scope of the invention set forth in the following claims.

What is claimed is:

1. A printed article comprising:
a substrate having a top surface;
a reflective layer formed over the top surface of the substrate;
a graphic image formed over the reflective layer;
a textured pattern formed over the graphic image; and
a transparent layer of uniform gloss formed over the textured pattern.

2. A printed article comprising:
a substrate having a top surface;
a reflective layer formed over the top surface of the substrate;
a graphic image formed over the reflective layer;
a transparent layer of uniform gloss formed over the graphic image and the reflective layer; and
a textured pattern of the same gloss level as the transparent layer of uniform gloss formed over the transparent layer of uniform gloss.

3. The printed article of claim 1 wherein the graphic image is formed over only a portion of the reflective layer.

4. The printed article of claim 2 wherein the graphic image is formed over only a portion of the reflective layer.

5. The printed article of claim 1 wherein the textured pattern is formed over only a portion of the graphic image and the reflective layer.

6. The printed article of claim 2 wherein the textured pattern is formed over only a portion of the graphic image and the reflective layer.

7. The printed article of claim 1 wherein the graphic image is formed through a four-color offset printing process where a base layer is printed and a four-color image is printed over the base layer.

8. The printed article of claim 2 wherein the graphic image is formed through a four-color offset printing process where a base layer is printed and a four-color image is printed over the base layer.

9. The printed article of claim 1 wherein the textured pattern is formed of transparent ink having rheological properties such that when the ink is printed, the ink flows into lines having a semi-cylindrical or convex shape when viewed in cross-section.

10. The printed article of claim 2 wherein the textured pattern is formed of transparent ink having rheological properties such that when the ink is printed, the ink flows into lines having a semi-cylindrical or convex shape when viewed in cross-section.

11. The printed article of claim 1 wherein the transparent ink includes glitter or pearls.

12. The printed article of claim 2 wherein the transparent ink includes glitter or pearls.

13. The printed article of claim 1 wherein the substrate includes a bottom surface with a second reflective layer formed on the bottom surface of the substrate, a second graphic image formed on the reflective layer, a second textured pattern formed on the graphic image, and a second transparent layer of uniform gloss formed on the second textured pattern and second reflective layer.

14. The printed article of claim 2 wherein the substrate includes a bottom surface with a second reflective layer formed on the bottom surface of the substrate, a second graphic image formed on the reflective layer, a second textured pattern formed on the graphic image, and a second transparent layer of uniform gloss formed on the second textured pattern and second reflective layer.

15. A printed article comprising:
a substrate having a top surface;
a reflective layer formed over the top surface of the substrate;
a graphic image formed over the reflective layer through a four-color offset printing process where a base layer is printed and a four-color image is printed over the base layer;
a textured pattern formed over the graphic image; and
a transparent layer of uniform gloss formed over the textured pattern and reflective layer.

16. A printed article comprising:
a substrate having a top surface;
a reflective layer formed over the top surface of the substrate;
a graphic image formed over the reflective layer through a four-color offset printing process where a base layer is printed and a four-color image is printed over the base layer;
a transparent layer of uniform gloss formed over the reflective layer and over the four-color image; and
a textured pattern of the same gloss level as the transparent layer of uniform gloss formed over the transparent layer of uniform gloss.

17. The printed article of claim 13 wherein the graphic image is formed over only a portion of the reflective layer.

18. The printed article of claim 13 wherein the textured pattern is formed over only a portion of the graphic image and the reflective layer.

19. The printed article of claim 14 wherein the graphic image is formed over only a portion of the reflective layer.

20. The printed article of claim 14 wherein the textured pattern is formed over only a portion of the graphic image and the reflective layer.

21. The printed article of claim 15 wherein the textured pattern is formed of transparent ink having rheological properties such that when the ink is printed, the ink flows into lines having a semi-cylindrical or convex shape when viewed in cross-section.

22. The printed article of claim 15 wherein the substrate includes a bottom surface image formed on the reflective layer, a second textured pattern formed on the graphic image, and a second transparent layer of uniform gloss formed on the second textured pattern and second reflective layer.

23. The printed article of claim 16 wherein the textured pattern is formed of transparent ink having rheological properties such that when the ink is printed, the ink flows into lines having a semi-cylindrical or convex shape when viewed in cross-section.

24. The printed article of claim 16 wherein the substrate includes a bottom surface with a second reflective layer formed on the bottom surface of the substrate, a second graphic image formed on the reflective layer, a second textured pattern formed on the graphic image, and a second transparent layer of uniform gloss formed on the second textured pattern and second reflective layer.

25. A method of forming a printed article, the method comprising the steps of:
providing a substrate having a top surface;
forming a reflective layer over the top surface of the substrate;
forming a graphic image over the reflective layer;
forming a textured pattern over the graphic image; and
forming a transparent layer of uniform gloss over the textured pattern and the reflective layer.

26. A method of forming a printed article, the method comprising the steps of:
providing a substrate having a top surface;
forming a reflective layer over the top surface of the substrate;
forming a graphic image over the reflective layer;
forming a transparent layer of uniform gloss over the reflective layer and the graphic image; and
forming a textured pattern which matches the gloss level of the transparent layer of uniform gloss over the graphic image.

27. The method of claim 25 wherein the reflective layer is formed over only a portion of the top surface of the substrate.

28. The method of claim 25 wherein the graphic image is formed over only a portion of the reflective layer.

29. The method of claim 25 wherein the textured pattern is formed over only a portion of the graphic image and only a portion of the reflective layer.

30. The method of claim 25 wherein the graphic image is formed through a four-color offset printing process where a base layer is printed and a four-color image is printed over the base layer.

31. The method of claim 25 wherein the textured pattern is formed of transparent ink having rheological properties such that when the ink is printed, the ink flows into lines having a semi-cylindrical or convex shape when viewed in cross-section.

32. The method of claim 25 wherein the substrate includes a bottom surface with a second reflective layer formed on the bottom surface of the substrate, a second graphic image formed on the reflective layer, a second textured pattern formed on the graphic image, and a second transparent layer of uniform gloss formed on the second textured pattern and second reflective layer.

33. The method of claim 26 wherein the reflective layer is formed over only a portion of the top surface of the substrate.

34. The method of claim 26 wherein the graphic image is formed over only a portion of the reflective layer.

35. The method of claim 26 wherein the textured pattern is formed over only a portion of the graphic image and only a portion of the reflective layer.

36. The method of claim 26 wherein the graphic image is formed through a four-color offset printing process where a base layer is printed and a four-color image is printed over the base layer.

37. The method of claim 26 wherein the textured pattern is formed of transparent ink having rheological properties such that when the ink is printed, the ink flows into lines having a semi-cylindrical or convex shape when viewed in cross-section.

38. The method of claim 26 wherein the substrate includes a bottom surface with a second reflective layer formed on the bottom surface of the substrate, a second graphic image formed on the reflective layer, a second textured pattern formed on the graphic image, and a second transparent layer of uniform gloss formed on the second textured pattern and second reflective layer.

39. A printed article comprising:
a substrate having a top surface;
a graphic image formed over the top surface of the substrate through a four-color offset printing process where a base layer is printed and a four-color image is printed over the base layer;
a textured pattern formed over the graphic image; and
a transparent layer of uniform gloss formed over the textured pattern and graphic image.

40. A printed article comprising:
a substrate having a top surface;
a graphic image formed over the top surface of the substrate through a four-color offset printing process where a base layer is printed and a four-color image is printed over the base layer;
a transparent layer of uniform gloss formed over the graphic image; and
a textured pattern of a gloss level that matches the gloss level of the transparent layer of uniform gloss formed over the transparent layer of uniform gloss and the graphic image.
